(19) United States
(12) Patent Application Publication
(10) Pub. No.: US 2026/0009646 A1
(43) Pub. Date: Jan. 8, 2026

(54) SYSTEMS AND METHODS FOR ESTIMATING A BIAS OF AN INERTIAL MEASUREMENT UNIT

(71) Applicant: Google LLC, Mountain View, CA (US)

(72) Inventors: Qiyue Zhang, Santa Clara, CA (US); Chao Guo, Los Altos, CA (US); Zhiheng Jia, Sunnyvale, CA (US); Hao Wu, San Francisco, CA (US)

(21) Appl. No.: 19/117,558

(22) PCT Filed: Oct. 20, 2022
(86) PCT No.: PCT/US2022/078415

§ 371 Date: Apr. 1, 2025

(51) Int. Cl. G01C 21/16; G01C 19/5712; G06T 7/246; G06T 7/277

(52) U.S. Cl. CPC G01C 21/183; G01C 19/5712; G01C 21/1656; G06T 7/248; G06T 7/277

(57) ABSTRACT

Motion tracking accuracy is an important feature to an immersive augmented or virtual reality experience. Motion tracking may be computed based on data from an inertial measurement unit of a device. This data may include errors that can vary with temperature. The disclosure describes a calibration process to reduce or eliminate these errors. The calibration process does not require special equipment and can be performed while the device is in use (i.e., online).

### FIELD OF THE DISCLOSURE

The present disclosure relates to devices that include an inertial measurement unit (IMU) and a camera and, more specifically, to a method for updating an estimated bias of measurements of the IMU using images from the camera.

### BACKGROUND

A mobile computing device can be configured to measure and track its motion using an inertial measurement unit (IMU). The IMU includes three gyroscopes configured to measure angular rates (i.e., rotations) in three dimensions and may further include three accelerometers configured to measure linear accelerations in three dimensions based on a force exerted by gravity (i.e., apparent acceleration). The three rotations and the three accelerations may be used to track motion with six degrees of freedom (6DOF). In other words, using the IMU, the motion tracking may track a 6DOF position/orientation (i.e., pose) of the mobile computing device.

### SUMMARY

An IMU may include errors in its measured rotation velocity or rotation rate (i.e., rotation) used for computing orientation and apparent acceleration used for computing displacement. These errors may be represented as a bias that is added to the ideal output for each dimension of the IMU. These biases may vary with temperature in ways that are unique for each device. The present disclosure describes methods and devices that can generate and update a calibration model (i.e., model) to compensate for these biases as the device is used (i.e., online calibration). In particular, an online calibration can analyze images captured by a camera to determine a motion measured by the camera and then compare this motion to the motion measured by the IMU in order to characterize the bias on the IMU. This online calibration can result in a model of the biases versus temperature, which can be used to correct IMU data in subsequent motion tracking.

In some aspects, the techniques described herein relate to a method including: receiving an inertial measurement unit (IMU) measurement corresponding to a motion of a device using an IMU of the device, the IMU measurement having a bias; receiving a temperature of the IMU; computing an estimated bias of the IMU for the temperature based on a model relating the estimated bias to the temperature; applying the estimated bias to the IMU measurement to generate a corrected IMU measurement; receiving a camera measurement corresponding to the motion of the device using a camera of the device; tracking the motion of the device using the camera measurement and the corrected IMU measurement; comparing the corrected IMU measurement to the camera measurement to determine that a model update criterion is satisfied; and updating the estimated bias for the temperature in the model (if the model update criterion is satisfied) based on a difference between the corrected IMU measurement and the camera measurement.

In some implementations, the method may relate to a method for motion-tracking wherein the updated estimated bias is (subsequently) used for correcting IMU measurements when tracking motion of the device. Updating the estimated bias may thus result in a calibration or recalibration of the device for an improved (e.g., more accurate) subsequent motion tracking, which takes a temperature dependency of a bias of an IMU measurement into account.

In some aspects, the techniques described herein relate to a motion-tracking device including: an inertial measurement unit (IMU) configured to collect an IMU measurement corresponding to a motion of the motion-tracking device, the IMU measurement having a bias; a temperature sensor configured to measure a temperature of the IMU; a camera configured to capture a sequence of images of an environment; and a processor configured by software instructions recalled from a memory to: compute an estimated bias of the IMU for the temperature based on a model relating the estimated bias to the temperature; apply the estimated bias to the IMU measurement to generate a corrected IMU measurement; collect a camera measurement corresponding to the motion of the motion-tracking device using the camera; track the motion of the motion-tracking device using the camera measurement and the corrected IMU measurement; compare the corrected IMU measurement to the camera measurement to determine that a model update criterion is satisfied; and update the estimated bias for the temperature in the model based on a difference between the corrected IMU measurement and the camera measurement.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a system block diagram of a motion-tracking device according to a possible implementation of the present disclosure.

FIG. 2 illustrates motion tracking based on a sequence of images captured by a camera according to a possible implementation of the present disclosure.

FIG. 3 is a system block diagram of an IMU configured for a 6DOF measurement according to a possible implementation of the present disclosure.

FIG. 4 is a perspective view of an implementation of a motion-tracking device according to a possible implementation of the present disclosure.

FIG. 5 is a flow chart for a motion tracking process including online calibration according to a possible implementation of the present disclosure.

FIG. 6 is a flow chart of online calibration according to a possible implementation of the present disclosure.

The components in the drawings are not necessarily to scale relative to each other. Like reference numerals designate corresponding parts throughout the several views.

### DETAILED DESCRIPTION

A mobile computing device configured to sense and track its motion (i.e., motion-tracking device) may include an IMU configured to measure a rotation rate (e.g., rotation velocity) to compute orientation and an acceleration relative to gravity (i.e., apparent acceleration) to compute displacement. An accuracy of the motion tracking can be negatively affected by errors (i.e., biases) in the orientation and displacement computed from the rotation rate (i.e., rotation) and the apparent acceleration (i.e., acceleration) measured by the IMU. For example, a first rotation measured by the IMU may include a first error (i.e., x-bias (bₓ)), a second rotation measured by the IMU may include a second error (i.e., y-bias (b_{y})), and a third rotation measured by the IMU may include a third error (i.e., z-bias (b_{z})). The biases may vary with temperature, and these temperature-varying biases can be reduced or eliminated using temperature models (i.e., thermal models, models) to estimate each bias. The models may be obtained (i.e., generated) through a calibration process at the time of fabrication (i.e., factory-set).

One technical problem with this factory-set calibration approach, is that different motion-tracking devices may each require a unique model (i.e., calibration) based on the unique structure (e.g., mechanical structure) and installed environment of the IMU, which can be different for each of the different motion-tracking devices. As a result, each motion-tracking device may require its own calibration, which may not be practical in a high-volume (e.g., consumer device) environment because obtaining the calibration may be time consuming (e.g., ≥8 hours). For example, a temperature-calibration process may include moving the motion-tracking device over a range of positions while at a fixed temperature, and then repeating this process for a plurality of temperatures in a range of temperatures. Gathering the data required for calibration may be time-consuming because time is required to heat/cool the motion-tracking device and settle at each of the plurality of temperatures before the movement can begin.

Another technical problem with this factory-set calibration approach is that the calibration for a motion-tracking device may change (e.g., lose accuracy) over time. For example, a temperature response of the IMU and/or the IMU's installed environment may change over time, thereby requiring an update to the calibration. Updating the calibration using the controlled temperature and positioning approach described above may require special test equipment, and as a result, a user could be required to return a motion-tracking device to the factory for recalibration whenever an accuracy of the calibration has changed significantly (e.g., above a threshold). Accordingly, based on cost and practicality concerns, a motion-tracking device intended for consumer use may simply use one fixed calibration for all devices, thereby leading to inaccurate motion tracking in some cases (e.g., at some temperatures, as the device ages). In some cases, this fixed calibration approach may require heating and cooling the device to a temperature that is suitable for the fixed calibration, thereby adding complexity and consuming additional power.

The disclosed systems and methods address these technical problems by providing a calibration process that is not time-consuming, does not require special equipment, and that can be updated while the motion-tracking device is in use (i.e., online). This online-calibration approach may have the technical effect of improving the motion tracking accuracy. In some cases, this motion tracking accuracy improvement can come without added costs and complexity to the motion-tracking device and without any decline in user experience.

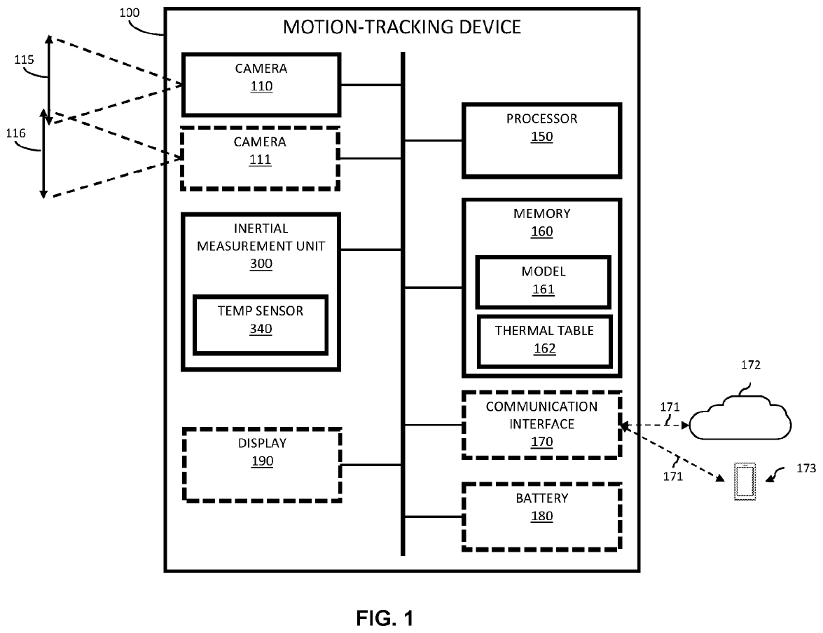

FIG. 1 is a block diagram of a motion-tracking device according to a possible implementation of the present disclosure. The motion-tracking device 100 includes a camera (e.g., first camera 110) configured to capture images of a field-of-view (e.g., first field-of-view 115). The motion-tracking device may further include a processor 150, and images from the first camera 110 may be analyzed by the processor to identify one or more features in the images for motion tracking. Tracking pixel positions of the one or more features over consecutive images may help to determine a motion (e.g., rotation) of the motion-tracking device 100.

In a possible implementation, the motion-tracking device 100 further includes a second camera 111 configured to capture images of a second field-of-view 116, which may overlap a portion of the first field-of-view 115. The cameras may be aligned and focused so that a first image (e.g., right image) of the first field-of-view and a second image (e.g., left image) of the second field-of-view may be combined to form a stereoscopic image. The stereoscopic images may help to track the one or more features in three dimensions.

Visual odometry (i.e., VO) is the process of tracking changes in the images captured by a device to track its changes in position/orientation (i.e., track its motion). Visual odometry can estimate movement by identifying and tracking image features (i.e., feature points) in sequential images captured by the camera (or cameras). The disclosed systems and methods can use visual odometry to determine a camera measurement (i.e., CAM_MEAS) corresponding to the motion of the motion-tracking device.

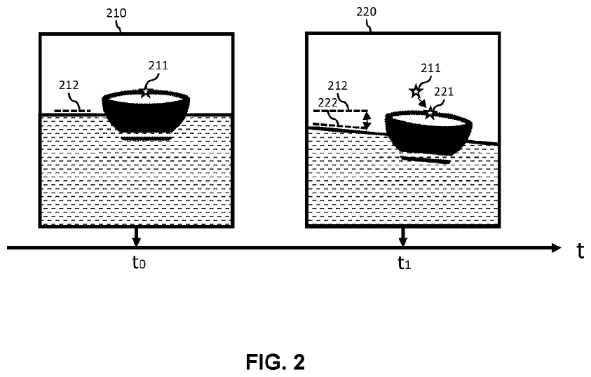

FIG. 2 illustrates motion tracking based on a sequence of images captured by a camera according to a possible implementation of the present disclosure. As shown, a first image 210 is captured by a camera of the motion-tracking device at a first time (t₀) and a second image 220 is captured by the camera of the motion-tracking device at a second time (t₁). While not required, the first image 210 and the second image 220 can be consecutive images of a video stream.

The first image 210 and the second image 220 may capture images of a rigid scene to determine its motion (i.e., egomotion). In the example shown, the first image 210 and the second image 220 include a bowl resting on a table. The bowl and the table are stationary during the period between the first time (t₀) and the second time (t₁) so the change in the position and the orientation of the table and the bowl can be assumed to result from a movement of the motion-tracking device. Analysis of the first image may include determining one or more features having a pixel position and/or pixel orientation in the first image. For example, the bowl in the first image 210 may define a first feature point 211 at a first pixel location, and the table in the first image 210 may define a first feature edge (i.e., first line 212) at a first angle. The bowl in the second image 220 may define a second feature point 221 at a second pixel location, and the table in the second image 220 may define a second feature edge (i.e., second line 222) at a second angle. A displacement related to the movement of the motion-tracking device may be computed by comparing the first location and the second location. For example, this comparison may include computing a horizontal change in location as a horizontal component (i.e., x-direction) of the displacement and computing a vertical change in location as a a vertical component (i.e., y-direction) of the displacement. A rotation related to the movement of the motion-tracking device may be computed by comparing the first angle to a second angle. For example, this comparison may include computing a roll angle as the difference between the first angle and the second angle.

The displacement and rotation illustrated in FIG. 2 are provided as examples, other feature points, lines, shapes, etc. may be recognized and tracked between images to determine other motions in other dimensions. For example, a size difference between the bowl in the first image 210 and the second image 220 may correspond to a movement towards (or away from) the bowl (i.e., z-direction displacement). Any, or all, of these computed displacements and rotations may be included in a camera measurement corresponding to the motion of the device. For example, a camera measurement may include any (or all) of a displacement in an x-direction (Dₓ), a displacement in a y-direction (D_{y}), a displacement in a z-direction (D_{z}), a rotation about an x-axis (ROLL), a rotation around a y-axis (PITCH), and a rotation around a z-axis (YAW).

Returning to FIG. 1, the motion-tracking device further includes an inertial measurement unit (i.e., IMU). The IMU can include a plurality of sensors that are aligned with a reference coordinate system having three dimensions (i.e., X, Y, Z). An IMU of a device may be configured to track its changes in position/orientation (i.e., track its motion) with respect to each of the three dimensions. The IMU measurement can be combined with the camera measurement described previously to help track the movement of the motion-tracking device. This form of motion tracking may be referred to as visual inertial odometry (VIO).

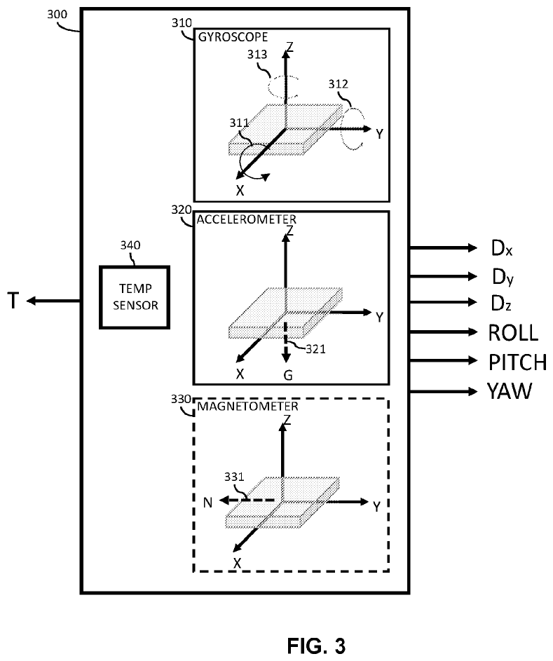

FIG. 3 is a system block diagram of an IMU for the motion-tracking device shown in FIG. 1. The IMU 300 may output a motion tracking measurement having six components (i.e., 6 degrees of freedom) including a displacement in an x-direction (Dₓ), a displacement in a y-direction (D_{y}), a displacement in a z-direction (D_{z}), a rotation about an x-axis (ROLL), a rotation around a y-axis (PITCH), and a rotation around a z-axis (YAW). The six components are relative to a coordinate system that may be aligned with, or define, a coordinate system of the motion-tracking device.

The IMU 300 may include a gyroscope module 310 including an X-axis gyroscope configured to measure a first rotation 311 (i.e., ROLL) around an X-axis of the coordinate system; a Y-axis gyroscope configured to measure a second rotation 312 (i.e., PITCH) around a Y-axis of the coordinate system; and a Z-axis gyroscope configured to measure a third rotation 313 (i.e., YAW) around a Z-axis of the coordinate system associated with the AR device.

A gyroscope of the IMU 300 may be implemented as a micro-electromechanical system (MEMS) in which a movement of a mass affixed to springs can be capacitively sensed to determine rotation. The alignment of the mass and the springs can determine the axis of the sensed rotation. Accordingly, the IMU 300 may include three MEMS gyroscopes, each aligned to sense a corresponding rotation around an axis of the coordinate system.

The IMU 300 may further include an accelerometer module 320 that includes an X-axis accelerometer configured to measure a first acceleration in an X-direction; a Y-axis accelerometer configured to measure a second acceleration in a Y-direction; and a Z-axis accelerometer configured to measure a third acceleration in a Z-direction.

An accelerometer of the IMU 300 may be implemented as a MEMS configured to capacitively sense a force (e.g., gravity 321) exerted on a movable mass to determine an acceleration. The accelerometer may sense displacement by processing (e.g., integration) the acceleration over time. Accordingly, the accelerometer module may include three MEMS accelerometers, each aligned to sense a corresponding displacement (Dx, Dy, Dz) along an axis of the coordinate system.

The mechanical nature of the MEMS sensors described above can make their responses sensitive to changes in temperature and/or to changes in their installed environment. For example, a temperature change or a force due to use (or misuse) of the motion-tracking device can alter the sensitivity of the MEMS devices. For example, dropping or bending the motion-tracking device can cause a change in the installed environment, thereby changing a response of a gyroscope or an accelerometer of the IMU.

The changes described above can make the sensed (i.e., measured) rotations (ROLL, PITCH, YAW) and/or displacements (Dx, Dy, Dz) differ from the actual rotations and/or displacements. The differences between a measured parameter (e.g., rotation, displacement) and an actual parameter is referred to as a bias. An output of the IMU may be considered as including an IMU measurement (IMU_MEAS) and a bias (BIAS). When the bias is zero, the measured parameter matches the actual parameter. Accordingly, it may be desirable to reduce the bias for any, or all, outputs of the IMU.

As mentioned above, the bias may be a function of temperature (i.e., BIAS(T)). Accordingly, the IMU 300 may be configured to output a temperature (T) from a temperature sensor 340. The temperature can approximate (e.g., within a degree Celsius) a temperature of the gyroscope module 310 and the accelerometer module 320. The temperature may be applied to a model relating an estimated bias to the temperature in order to generate an estimated bias. The estimated bias can be applied (e.g., subtracted) from the output of the IMU in order to obtain (i.e., generate) a corrected IMU measurement (CORR_IMU_MEAS) in which the bias is reduced or eliminated.

In a possible implementation the temperature sensor 340 is not included as part of the IMU 300 but rather is included in the motion-tracking device 100 on, or near, the IMU 300 so as to measure a temperature (T) that corresponds to the temperature of the gyroscope module 310 and the accelerometer module 320.

In a possible implementation, the IMU 300 can further include a magnetometer 330 that includes an X-axis magnetometer configured to measure a first magnetic field strength (i.e., Hₓ) an X-direction of the coordinate system, a Y-axis magnetometer configured to measure a second magnetic field strength (i.e., H_{y}) in a Y-direction of the coordinate system, and a Z-axis magnetometer configured to measure a third magnetic field strength (i.e., H_{z}) in a Z-direction of the coordinate system. The magnetic field strengths may be relative to the Earth's magnetic field 331 (i.e., north (N)).

Returning to FIG. 1, the motion-tracking device 100 further includes a memory 160. The memory may be a non-transitory computer-readable medium and may be configured to store instructions that, when executed by the processor 150, can configure the motion tracking device to perform the disclosed methods. For example, the memory 160 may be configured to store the model 161 related to the estimated bias to the temperature. The memory may be further configured to store a thermal table 162 that can be used with the mode, as will be described below.

The motion-tracking device 100 may further include a display 190. For example, the display 190. In a possible implementation, the display 190 is a heads-up display (i.e., HUD). The motion-tracking device 100 may further include a battery 180. The battery may be configured to provide energy to the subsystems, modules, and devices of the motion-tracking device 100 to enable their operation. The battery 180 may be rechargeable and have an operating life (e.g., lifetime) between charges.

The motion-tracking device 100 may further include a communication interface 170. The communication interface may be configured to communicate information digitally over a wireless communication link 171 (e.g., WiFi, Bluetooth, etc.). For example, the motion-tracking device may be communicatively coupled to a network 172 (i.e., the cloud) or a device (e.g., mobile phone 173) over the wireless communication link 171. The wireless communication link may allow operations of a computer-implemented method to be divided between devices and/or could allow for remote storage of the model 161 and/or the thermal table 162.

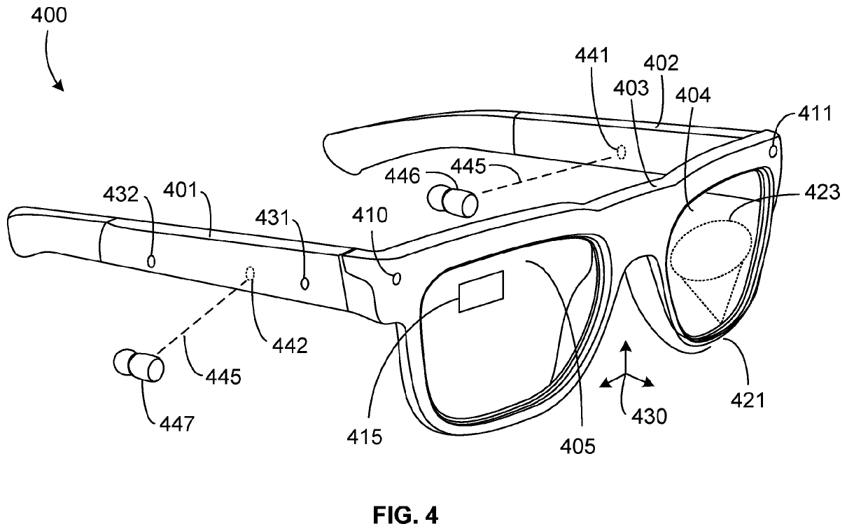

FIG. 4 is a perspective view of a possible implementation of a motion-tracking device. The motion-tracking device may be smart glasses configured for augmented reality (i.e., augmented reality glasses). The AR glasses 400 can be configured to be worn on a head and face of a user. The AR glasses 400 include a right earpiece 401 and a left earpiece 402 that are supported by the ears of a user. The AR glasses further include a bridge portion 403 that is supported by the nose of the user so that a left lens 404 and a right lens 405 can be positioned in front a left eye of the user and a right eye of the user respectively. The portions of the AR glasses can be collectively referred to as the frame of the AR glasses. The frame of the AR glasses can contain electronics to enable function. For example, the frame may include a battery, a processor, a memory (e.g., non-transitory computer readable medium), electronics to support sensors (e.g., cameras, depth sensors, etc.), at least one position sensor (e.g., an inertial measurement unit) and interface devices (e.g., speakers, display, network adapter, etc.). The AR glasses may display and sense an environment relative to a coordinate system 430. The coordinate system 430 can be aligned with the head of a user wearing the AR glasses. For example, the eyes of the user may be along a line in a horizontal (e.g., x-direction) direction of the coordinate system 430.

A user wearing the AR glasses can experience information displayed in an area corresponding to the lens (or lenses) so that the user can view virtual elements within their natural field of view. Accordingly, the AR glasses 400 can further include a heads-up display (i.e., HUD) configured to display visual information at a lens (or lenses) of the AR glasses. As shown, the heads-up display may present AR data (e.g., images, graphics, text, icons, etc.) on a portion 415 of a lens (or lenses) of the AR glasses so that a user may view the AR data as the user looks through a lens of the AR glasses. In this way, the AR data can overlap with the user's view of the environment. In a possible implementation, the portion 415 can correspond to (i.e., substantially match) area(s) of the right lens 405 and/or left lens 404.

The AR glasses 400 can include an IMU that is configured to track motion of the head of a user wearing the AR glasses. The IMU may be disposed within the frame of the AR glasses and aligned with the coordinate system 430 of the AR glasses 400.

The AR glasses 400 can include a first camera 410 that is directed to a first camera field-of-view that overlaps with the natural field-of-view of the eyes of the user when the glasses are worn. In other words, the first camera 410 can capture images of a view aligned with a point-of-view (POV) of a user (i.e., an egocentric view of the user).

In a possible implementation, the AR glasses 400 can further include a second camera 411 that is directed to a second camera field-of-view that overlaps with the natural field-of-view of the eyes of a user when the glasses are worn. The second camera 411 and the first camera 410 may be configured to capture stereoscopic images of the field of view of the user that includes depth information about objects in the field of view of the user. The depth information may be generated using visual odometry and used as part of the camera measurement (i.e., CAM_MEAS) corresponding to the motion of the motion-tracking device.

In a possible implementation, the AR glasses may further include a depth-sensor configured to capture a depth image corresponding to the field-of-view of the user. The depth image includes pixels having pixel values that correspond to depths (ranges) to objects measured at positions corresponding to the pixel positions in the depth image.

The AR glasses 400 can further include an eye-tracking sensor. The eye tracking sensor can include a right-eye camera and/or a left-eye camera 421. As shown, a left-eye camera 421 can be located in a portion of the frame so that a left FOV 423 of the left-eye camera 421 includes the left eye of the user when the AR glasses are worn.

The AR glasses 400 can further include one or more microphones. The one or more microphones can be spaced apart on the frames of the AR glasses. As shown in FIG. 4, the AR glasses can include a first microphone 431 and a second microphone 432. The microphones may be configured to operate together as a microphone array. The microphone array can be configured to apply sound localization to determine directions of the sounds relative to the AR glasses.

The AR glasses may further include a left speaker 441 and a right speaker 442 configured to transmit audio to the user. Additionally, or alternatively, transmitting audio to a user may include transmitting the audio over a wireless communication link 445 to a listening device (e.g., hearing aid, earbud, etc.). For example, the AR glasses may transmit audio to a left wireless earbud 446 and to a right earbud 447.

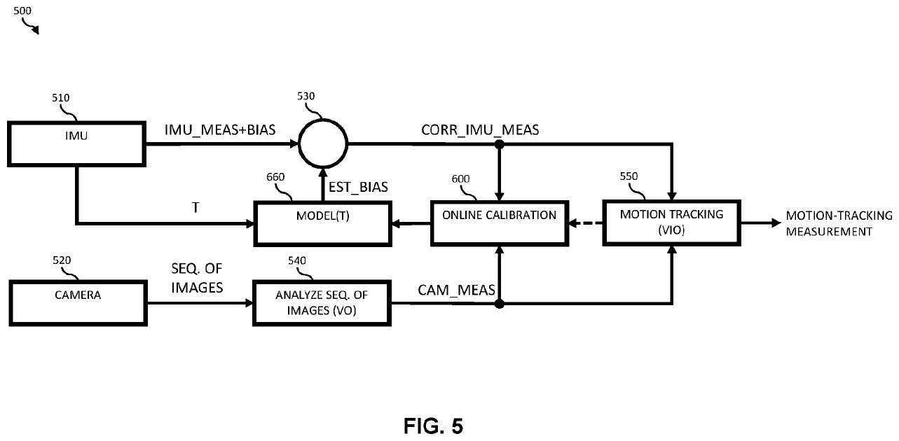

FIG. 5 is a flow chart for a motion-tracking process (i.e., method) including online calibration according to a possible implementation of the present disclosure. The method 500 may be performed using a motion-tracking device (i.e., device), such as the AR glasses (i.e., FIG. 1) or a mobile phone. The method 500 includes receiving (e.g., collecting) an IMU measurement (IMU_MEAS) corresponding to a motion of the motion-tracking device using an IMU of the device. The IMU measurement includes a bias (BIAS) corresponding to a difference between the actual motion of the device and the IMU measurement of the motion of the device.

The method 500 further includes receiving (e.g., measuring) a temperature (T) of the IMU. As described previously, the temperature may be measured using a temperature sensor included as a module of the IMU. Accordingly, the IMU may output the temperature (T) in addition to the IMU measurement including the bias (i.e., IMU_MEAS+BIAS).

The temperature (T) may be used to compute an estimated bias (EST_BIAS) of the IMU. For example, the estimated bias of the IMU for a temperature (T) may be computed based on a model relating the estimated bias to the temperature (i.e., MODEL(T)=EST_BIAS). The model may include equations relating the estimated bias to a temperature, and a processor may recall the model from a memory of the device and apply the temperature to the model to calculate the estimated bias.

The method 500 further includes applying 530 the estimated bias to the IMU measurement to generate a corrected IMU measurement (CORR_IMU_MEAS). For example, the estimated bias (EST_BIAS) may be subtracted from the IMU measurement including the bias (i.e., IMU_MEAS+BIAS) to generate the corrected IMU measurement (CORR_IMU_MEAS) in which a difference between the actual motion of the device and the motion measured by the IMU is reduced or eliminated. The corrected IMU measurement may include position/orientation changes described by 6DOF.

The method 500 further includes using a camera 520 of the device to capture a plurality of images. For example, the images may be a sequence of images in a video stream. The sequence of images may include a first image collected (i.e., captured) at a first time and a second image collected (i.e., captured) at a second time. The first image and the second image can be analyzed 540 to compare features (e.g., recognized points, lines, shapes in the image) to compute a camera measurement (CAM_MEAS) corresponding to the motion of the device based on the comparison. The camera measurement (CAM_MEAS) may include position/orientation changes described by 6DOF. For example, a change in a position in an x-dimension of a coordinate system of a motion tracking device, a change in a position in a y-coordinate system of the motion tracking device and a change in a z-coordinate system of the motion tracking device may be computed and stored as part of the camera measurement.

The method 500 further includes tracking the motion of the device using the camera measurement (CAM_MEAS) and the corrected IMU measurement (CORR_IMU_MEAS). The motion tracking 550 may include a visual inertial odometry (VIO) process in which IMU motion data is combined with camera motion data to determine a measurement of the motion.

The motion tracking 550 may include applying the corrected IMU measurement (CORR_IMU_MEAS) and the camera measurement (CAM_MEAS) to a Kalman filter (e.g., extended Kalman filter) which can reduce the effects of noise in the motion-tracking measurement. The extended Kalman filter can also monitor a state of the bias in the corrected IMU measurement to determine when the model 660 needs to be updated (e.g., changed, supplemented). For example, changes to the IMU 510 may make the estimated bias (EST_BIAS) generated by the model 660 less effective for reducing the bias from the IMU measurement.

The extended Kalman filter can use the IMU measurements and images from the camera to estimate the motion of the device (e.g., 6 DOF measurement) as well as the errors (i.e., variations) associated with the estimate. The errors measured for various temperatures can be used to build/train a IMU temperature error model (i.e., model) of the device. For example, the extended Kalman filter can characterize how well the estimated bias is correcting (i.e., reducing) the actual bias of the IMU. As the bias prediction (i.e., estimate) drifts away from the actual bias, an online calibration process 600 (i.e., calibration method) can help to correct the estimate.

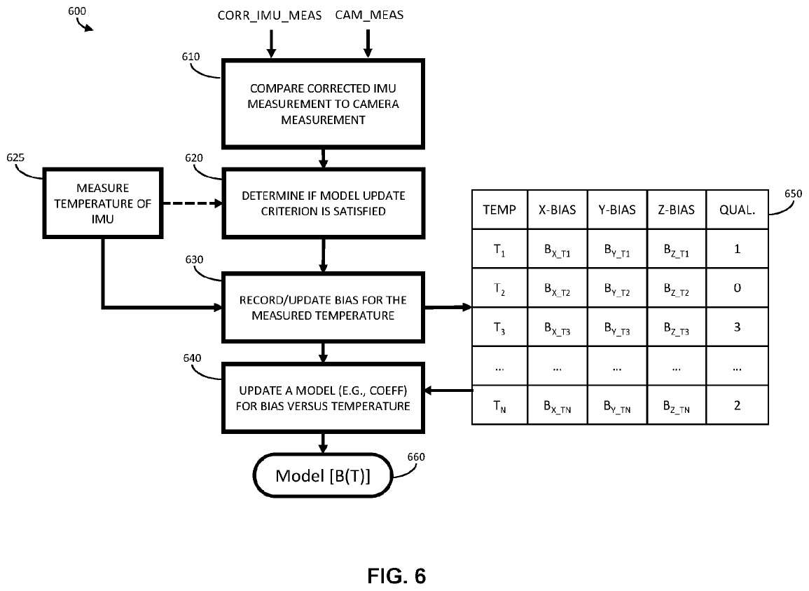

FIG. 6 is a flow chart of an online calibration process (i.e., method) according to a possible implementation of the present disclosure. The online calibration process 600 includes comparing 610 the corrected IMU measurement to the camera measurement.

The online calibration process 600 further includes determining 620 if a model update criterion is satisfied. This determination may include characterizing how well the predicted bias has corrected the actual bias of the IMU for a measured 625 temperature. For example, a significant (e.g., above a threshold) bias change (ΔB) may trigger training, or retraining, the model. Further, a significant (e.g., above a threshold) temperature change (ΔT) may trigger training, or retraining, the model.

As previously described, an extended Kalman filter used for motion tracking may characterize how well the predicted bias is correcting the actual bias of the IMU for the temperature in question. The characterization may include determining a change in bias (i.e., bias change). The bias change for a temperature may be based on a difference between the corrected IMU measurement (CORR_IMU_MEAS) and the camera measurement (CAM_MEAS). For example, if the corrected IMU measurement includes a first 6DOF measurement and the camera measurement includes a second 6DOF measurement then a difference may be computed based on (e.g., averaged) corresponding differences between each degree of freedom in the first 6DOF measurement and the second 6DOF measurement.

When the model update criterion is satisfied, the online calibration process 600 further includes recording and/or updating 630 a bias for the measured temperature in the model. For example, the model may include a thermal table 650 that relates temperatures to the biases of the IMU. For example, the thermal table 650 can include rows that each include a temperature (i.e., T1), a first estimated bias in an x-dimension (i.e., B_{X_T1})), a second estimated bias in a y-dimension (i.e., B_{Y_T1})), a third estimated bias in a z-dimension (i.e., B_{Z_T1})), and a quality (i.e., QUAL).

The quality may correspond to a number of times that the biases for the temperature have been updated. The quality of biases interpolated from other measurements may be zero. For example, the quality of a row having biases interpolated from neighboring rows may be zero. The quality may correspond to how many data points in a given time period (e.g., 24 hours) are used to create the estimate of the biases. The quality may be used to weigh an average used to determine a bias.

Estimating a bias for a temperature may include interpolating bias values from values in the thermal table 650. For example, a spline (e.g., cubic spline) interpolation may be fit to the bias values in the thermal table 650. In another implementation, a least squares solution may be fit to the bias values in the thermal table. The quality factors in the thermal table 650 may be used to select a fitting technique used to determine a bias for a temperature from values in the thermal table. For example, when the quality is less than a threshold (e.g., 10), then a least square fit may be used, otherwise a spline interpretation may be used.

The method may further include updating 640 a model (e.g., coefficients) based on biases in the thermal table 650. For example, coefficients of a cubic spline may be determined to so that a piecewise curve (e.g., Bₓ(T)=aᵢ+bᵢT+cᵢT²+dᵢT³, where i is the piece of the spline) passes through all the bias/temperatures of the thermal table. The resulting model 640 (e.g., Bx(T), By(T), Bz(T)) for the gyroscopes and/or accelerometers may be stored locally on an internal of the device or may be stored remotely on a memory in communication with the device (e.g., over a network).

In the following paragraphs, some examples are described.

Example 1. A method (for estimating a bias of an IMU) comprising: receiving an inertial measurement unit (IMU) measurement corresponding to a motion of a device using an IMU of the device, the IMU measurement having a bias; receiving a temperature of the IMU; computing an estimated bias of the IMU for the temperature based on a model relating the estimated bias to the temperature; applying the estimated bias to the IMU measurement to generate a corrected IMU measurement; receiving a camera measurement corresponding to the motion of the device using a camera of the device; tracking the motion of the device using the camera measurement and the corrected IMU measurement; comparing the corrected IMU measurement to the camera measurement to determine that a model update criterion is satisfied; and updating the estimated bias for the temperature in the model based on a difference between the corrected IMU measurement and the camera measurement.

Example 2. The method as in example 1, wherein receiving the IMU measurement includes collecting a rotation rate (e.g., rotation velocity) from a gyroscope of the IMU.

Example 3. The method as in example 1 or 2, wherein receiving the IMU measurement includes collecting an acceleration (e.g., apparent acceleration) from an accelerometer of the IMU.

Example 4. The method as in any of the preceding examples, wherein receiving the camera measurement corresponding to the motion of the device using a camera of the device includes: collecting a first image at a first time and a second image at a second time; determining a first location of a feature in the first image; determining a second location of the feature in the second image; and comparing the first location to the second location to compute the camera measurement corresponding to the motion of the device.

Example 5. The method for motion tracking as in any of the preceding examples, wherein the model relating the estimated bias to the temperature includes a spline interpolation.

Example 6. The method as in example 5, wherein the spline interpolation is based on a thermal table including temperatures and estimated biases updated over time.

Example 7. The method as in example 6, wherein the thermal table includes rows that each include a temperature, a first estimated bias in an x-dimension, a second estimated bias in a y-dimension, a third estimated bias in a z-dimension, and a quality corresponding to a number of times each row has been updated.

Example 8. The method for motion tracking as in example 7, wherein the quality of a row having the first estimated bias, the second estimated bias, and the third estimated bias interpolated from other rows is zero.

Example 9. The method as in any of the preceding examples, wherein comparing the corrected IMU measurement to the camera measurement to determine that a model update criterion is satisfied includes detecting a bias change for the temperature based on a difference between the corrected IMU measurement and the camera measurement.

Example 10. The method as in example 9, wherein detecting the bias change for the temperature includes an extended Kalman filter.

Example 11. The method as in any of the preceding examples, wherein comparing the corrected IMU measurement to the camera measurement to determine that a model update criterion is satisfied includes detecting a temperature change.

Example 12. The method as in any of the preceding examples, wherein the bias corresponds to a change in a sensitivity of a micro-electromechanical gyroscope corresponding to a change in the temperature of the IMU.

Example 13. The method as in any of the preceding examples, wherein the device is augmented-reality glasses.

Example 14. A motion-tracking device including: an inertial measurement unit (IMU) configured to collect an IMU measurement corresponding to a motion of the motion-tracking device, the IMU measurement having a bias; a temperature sensor configured to measure a temperature of the IMU; a camera configured to capture a sequence of images of an environment; and a processor configured by software instructions recalled from a memory to: compute an estimated bias of the IMU for the temperature based on a model relating the estimated bias to the temperature; apply the estimated bias to the IMU measurement to generate a corrected IMU measurement; collect a camera measurement corresponding to the motion of the motion-tracking device using the camera; track the motion of the motion-tracking device using the camera measurement and the corrected IMU measurement; compare the corrected IMU measurement to the camera measurement to determine that a model update criterion is satisfied; and update the estimated bias for the temperature in the model based on a difference between the corrected IMU measurement and the camera measurement.

Example 15. The motion-tracking device as in example 14, wherein to collect the camera measurement, the processor is further configured to: receive a first image at a first time and a second image a second time; determine a first location of a feature in the first image; determine a second location of the feature in the second image; and compare the first location to the second location to compute the camera measurement corresponding to the motion of the motion-tracking device.

Example 16. The motion-tracking device as in example 14 or 15, wherein the model relating the estimated bias to the temperature includes a spline interpolation.

Example 17. The motion-tracking device as in example 16, wherein the spline interpolation is based on a thermal table including temperatures and estimated biases updated over time, the thermal table stored in the memory of the motion-tracking device.

Example 18. The motion-tracking device as in example 17, wherein the thermal table includes rows that each include a temperature, a first estimated bias in an x-dimension, a second estimated bias in a y-dimension, a third estimated bias in a z-dimension, and a quality corresponding to a number of times each row has been updated.

Example 19. The motion-tracking device as in any of the examples 14 through 18, wherein the bias corresponds to a change in a sensitivity of a micro-electromechanical gyroscope corresponding to a change in the temperature of the IMU.

Example 20. The motion-tracking device as in any of the examples 14 through 19, wherein the motion-tracking device is augmented-reality glasses.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Some implementations may be implemented using various semiconductor processing and/or packaging techniques. Some implementations may be implemented using various types of semiconductor processing techniques associated with semiconductor substrates including, but not limited to, for example, Silicon (Si), Gallium Arsenide (GaAs), Gallium Nitride (GaN), Silicon Carbide (SiC) and/or so forth.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

1. A method comprising:
receiving a sensor measurement corresponding to a motion of a device using a sensor configured to measure movement of the device, the sensor measurement having a bias;
computing an estimated bias of the sensor for a temperature based on a model relating the estimated bias to the temperature;
applying the estimated bias to the sensor measurement to generate a corrected sensor measurement;
receiving a camera measurement corresponding to the motion of the device using a camera of the device; and
updating the estimated bias for the temperature in the model based on a difference between the corrected sensor measurement and the camera measurement.

2. The method according to claim 1, wherein receiving the sensor measurement includes collecting a rotation rate from a gyroscope of the sensor.

3. The method according to claim 1, wherein receiving the sensor measurement includes collecting an acceleration from an accelerometer of the sensor.

4. The method according to claim 1, wherein receiving the camera measurement corresponding to the motion of the device using a-the camera of the device includes:
collecting a first image at a first time and a second image at a second time;
determining a first location of a feature in the first image;
determining a second location of the feature in the second image; and
comparing the first location to the second location to compute the camera measurement corresponding to the motion of the device.

5. The method according to claim 1, wherein the model relating the estimated bias to the temperature includes a spline interpolation.

6. The method according to claim 5, wherein the spline interpolation is based on a thermal table including temperatures and estimated biases updated over time.

7. The method according to claim 6, wherein the thermal table includes rows that include a temperature measurement, a first estimated bias in an x-dimension, a second estimated bias in a y-dimension, a third estimated bias in a z-dimension, and a quality corresponding to a number of times a row has been updated.

8. The method according to claim 7, wherein the quality is zero when the first estimated bias, the second estimated bias, and or the third estimated bias is interpolated from other rows in the thermal table.

9. The method according to claim 1, further comprising comparing the corrected sensor measurement to the camera measurement to determine that a model update criterion is satisfied by:
detecting a bias change for the temperature, the bias change based on the difference between the corrected sensor measurement and the camera measurement.

10. The method according to claim 9, wherein detecting the bias change for the temperature includes an extended Kalman filter.

11. The method according to claim 1, wherein comparing the corrected sensor measurement to the camera measurement to determine that a model update criterion is satisfied includes:
detecting a temperature change.

12. The method according to claim 1, wherein the bias corresponds to a change in a sensitivity of a micro-electromechanical gyroscope corresponding to a change in the temperature of the sensor.

13. The method according to claim 1, wherein the device is augmented-reality glasses.

14. A motion-sensing device including:
a sensor configured to collect a sensor measurement corresponding to a motion of the motion-sensing device, the sensor measurement having a bias;
a temperature sensor configured to measure a temperature of the sensor;
a camera configured to capture a sequence of images of an environment; and
a processor configured by software instructions recalled from a memory to:
compute an estimated bias of the sensor for the temperature based on a model relating the estimated bias to the temperature;
apply the estimated bias to the sensor measurement to generate a corrected sensor measurement;
collect a camera measurement corresponding to the motion of the motion-sensing device using the camera; and
update the estimated bias for the temperature in the model based on a difference between the corrected sensor measurement and the camera measurement.

15. The motion-sensing device according to claim 14, wherein to collect the camera measurement, the processor is further configured to:
receive a first image at a first time and a second image a second time;
determine a first location of a feature in the first image;
determine a second location of the feature in the second image; and
compare the first location to the second location to compute the camera measurement corresponding to the motion of the motion-sensing device.

16. The motion-sensing device according to claim 14, wherein the model relating the estimated bias to the temperature includes a spline interpolation.

17. The motion-sensing device according to claim 16, wherein the spline interpolation is based on a thermal table including temperatures and estimated biases updated over time, the thermal table stored in the memory of the motion-sensing device.

18. The motion-sensing device according to claim 17, wherein the thermal table includes rows that each include a temperature measurement, a first estimated bias in an x-dimension, a second estimated bias in a y-dimension, a third estimated bias in a z-dimension, and a quality corresponding to a number of times a row has been updated.

19. The motion-sensing device according to claim 14, wherein the bias corresponds to a change in a sensitivity of a micro-electromechanical gyroscope corresponding to a change in the temperature of the sensor.

20. The motion-sensing device according to claim 14, wherein the motion-sensing device is augmented-reality glasses.
